(19) United States
(12) Patent Application Publication
(10) Pub. No.: US 2006/0085817 A1
(43) Pub. Date: Apr. 20, 2006

(54) Multi-media device having function of backing up broadcasting contents in home network environment and method of backing up the broadcasting contents

(75) Inventors: Bong-seon Kim, Seongnam-si (KR); Myung-sun Kim, Uiwang-si (KR); Su-hyun Nam, Seoul (KR); Sang-su Choi, Bucheon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/234,416

(22) Filed: Sep. 26, 2005

Related U.S. Application Data
(60) Provisional application No. 60/619,945, filed on Oct. 20, 2004.

(30) Foreign Application Priority Data
Oct. 25, 2004 (KR) 10-2004-0085338

(51) Int. Cl. H04N 5/445; H04N 7/025; H04N 7/10; H04N 7/173; G06F 3/00

(52) U.S. Cl. 725/34; 725/42; 725/89

(57) ABSTRACT

A multimedia device having a function of backing up received broadcasting contents in a home network environment and a method of backing up the broadcasting contents. The multimedia device includes a local storage unit for storing received broadcasting contents, and a storage controlling unit for controlling storage of the broadcasting contents. When a space of the local storage unit is insufficient or when a user requests a backup, the storage controlling unit controls the device to transfer some of the stored broadcasting contents to a backup device. Accordingly, the multimedia device backs up the received broadcasting contents in various backup devices, thereby efficiently controlling the storage space of the local storage unit. Also, the multimedia device can prevent the backed-up contents from being arbitrarily reproduced or copied by another unauthorized multimedia device.

This application claims the benefit of Korean Patent Application No. 10-2004-0085338, filed on Oct. 25, 2004, in the Korean Intellectual Property Office, and U.S. Provisional Application No. 60/619,945, filed on Oct. 20, 2004, in the U.S. Patent and Trademark Office, the disclosures of which are incorporated herein in their entirety by reference.

### BACKGROUND OF THE INVENTION

1. Field of the Invention

The present invention relates to storage of broadcasting contents, and more particularly, to a multimedia device having a function of backing up broadcasting contents in a home network environment and a method of backing up the broadcasting contents.

2. Description of the Related Art

Research and development of multi-media devices for receiving and reproducing broadcasting contents in a home network environment are being actively made of late. Multi-media contents, such as, movies, music, and games, are distributed to users through various media, such as, terrestrial waves, satellites, cables, or digital multimedia broadcasting (hereinafter, referred to as DMB). Users reproduce received contents using a multimedia device, such as, a set-top box (hereinafter, referred to as an STB), a digital television (DTV) receiver including an STB, a personal video recorder (hereinafter, referred to as a PVR), or the like. Particularly, a multimedia device currently under development not only reproduces received broadcasting contents but may also store the received broadcasting contents in a local storage unit, e.g., a hard disc.

However, after a predetermined period of time lapses, the amount of broadcasting contents stored may increase and exceed a capacity of the local storage unit included in the multimedia device. In this case, some of the stored broadcasting contents should be deleted to store new broadcasting contents. However, users may not want to delete purchased broadcasting contents from a multimedia device due to lack of capacity of a local storage unit included in the multimedia device. In this case, broadcasting contents desired by the users may not be stored due to the lack of the capacity of the local storage unit.

### SUMMARY OF THE INVENTION

The present invention provides a method of backing up broadcasting contents, in which when a capacity of a local storage unit is insufficient, pre-stored contents are transferred to and stored in a backup device desired by a user instead of being deleted.

The present invention also provides a multimedia device having a function of backing up broadcasting contents in a home network environment.

The present invention also provides a method of preventing broadcasting contents backed up by a multimedia device from being arbitrarily reproduced or copied by another unauthorized multimedia device.

According to an exemplary embodiment of the present invention, there is provided a device for receiving broadcasting contents, the device comprising: a local storage unit storing received broadcasting contents; and a storage controlling unit controlling storage of the broadcasting contents. When a space of the local storage unit is insufficient or when a user requests a backup, the storage controlling unit controls the device to transfer some of the stored broadcasting contents to a storage backup device.

The device may further comprise a packaging unit for combining the transferred broadcasting contents with information about digital authorization and newly encoding a result of the combination.

The information about the digital authorization may be produced using information unique to the device.

The information about the digital authorization may be produced using license information.

The device may further comprise a receiving unit for receiving the broadcasting contents via a broadcasting medium selected from a terrestrial wave broadcasting medium, a cable broadcasting medium, a satellite broadcasting medium, a digital multimedia broadcasting medium, or a combination of two or more of the aforementioned broadcasting media.

The backup device may be at least one device selected from a multimedia device connected to the broadcasting contents receiving device over a network and including a storage unit, a mobile device including a storage unit, a personal video recorder including a storage unit, a settop box including a storage unit, and a separable information storage media.

The device may further comprise a user interface for selecting broadcasting contents to be transferred to the backup device, and for selecting a backup device to receive the transferred broadcasting contents.

According to another exemplary embodiment of the present invention, there is provided a method of receiving and storing broadcasting contents, comprising the operations of: checking a capacity of a storage space to store the received broadcasting contents; and transferring some of the stored broadcasting contents to in a backup device when it is checked that the storage space is insufficient.

The method may further comprise an operation of combining the transferred broadcasting contents with information about digital authorization and newly encoding a result of the combination, before the operation of transferring and storing the some broadcasting contents in the backup device.

Before the operation of checking the capacity of the storage space, the method may further comprise an operation of receiving the broadcasting contents via a broadcasting medium among a terrestrial wave broadcasting medium, a cable broadcasting medium, a satellite broadcasting medium, a digital multimedia broadcasting medium, or a combination of two or more of the aforementioned broadcasting media.

Before transferring the broadcasting contents in the backup device, the method may further comprise an operation of receiving information about the selection of contents of the broadcasting contents to be transferred to a backup device in order to back up the selected contents.

According to another exemplary embodiment of the present invention, there is provided a computer readable recording medium which records a computer program code for executing the method of receiving and storing the broadcasting contents.

According to another exemplary embodiment of the present invention, there is provided a method of backing up stored broadcasting contents, comprising: receiving a request of a user for a backup of the stored broadcasting contents; combining the broadcasting contents to be backed up with information about digital authorization and newly encoding combined data; and transferring the newly encoded data to and storing the newly encoded data in a backup device.

### BRIEF DESCRIPTION OF THE DRAWINGS

The above and other features and advantages of the present invention will become more apparent by describing in detail exemplary embodiments thereof with reference to the attached drawings in which:

FIG. 1 is a schematic diagram of a multimedia device having a function of backing up broadcasting contents in a home network environment, according to an embodiment of the present invention;

FIG. 2 is a block diagram of a structure of the multimedia device having the backup function of FIG. 1;

FIG. 3 is a flowchart illustrating a method of backing up broadcasting contents, according to an embodiment of the present invention;

FIGS. 4A and 4B are flowcharts illustrating examples of a contents packaging method using digital authorization information shown in FIG. 3;

FIG. 5 is a reference view illustrating the contents packaging methods of FIGS. 4A and 4B;

FIG. 6 illustrates an embodiment of a protocol in which binds digital authorization information and contents are bound together;

FIG. 7 illustrates another embodiment of a protocol in which digital authorization information and contents are bound together;

FIG. 8 illustrates a user interface for selecting a backup device, according to an embodiment of the present invention;

FIG. 9 illustrates a user interface for selecting contents to be backed up, according to an embodiment of the present invention;

FIG. 10 illustrates an example of a user interface for informing users of a capacity of a local storage unit during backup;

FIG. 11 is a flowchart illustrating a method of preventing contents backed up by a multimedia device from being copied or reproduced by another unauthorized multimedia device; and

FIG. 12 is a reference view illustrating a method of preventing contents backed up by a multimedia device from being copied or reproduced by another unauthorized multimedia device.

### DETAILED DESCRIPTION OF THE PREFERRED EMBODIMENTS

The preferred embodiments of the present invention will now be described in detail with reference to the accompanying drawings, in which the preferred embodiments of the invention are shown.

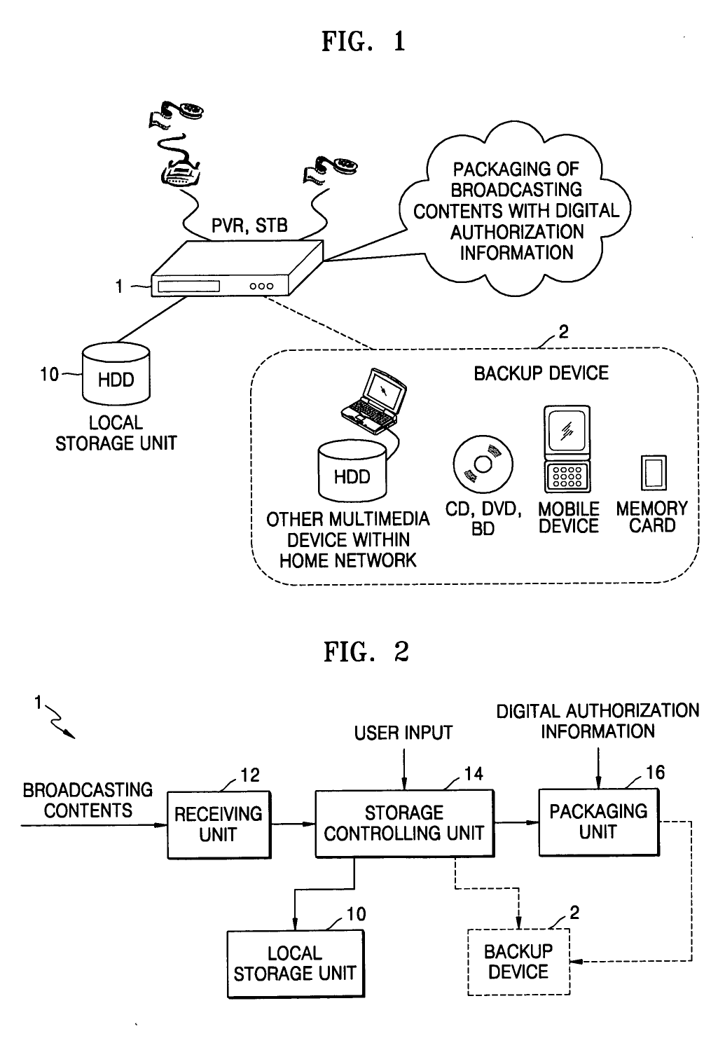

FIG. 1 is a schematic diagram of a multimedia device 1 having a function of backing up broadcasting contents in a home network environment, according to a preferred embodiment of the present invention. Referring to FIG. 1, the multimedia device 1 includes a local storage unit 10 that backs up broadcasting contents received via various media (e.g., terrestrial broadcasting, satellite broadcasting, cable broadcasting, or digital multimedia broadcasting (DMB)), in various types of backup devices 2.

Examples of the backup device 2 include a local storage unit of a multimedia device connected to the multimedia device 1 via a network in a home network environment, optical discs (e.g., a compact disc (CD), a digital versatile disc (DVD), and a blue-ray disc (BD)), personal digital assistants (PDAs), mobile devices (e.g., a cellular phone), portable storage devices (e.g., a memory card), and the like.

Particularly, the multimedia device 1 packages broadcasting contents to be backed up together with digital authorization information to be described later and sends the package to the backup device 2. Hence, arbitrary reproduction or copying of backed-up broadcasting contents by another unauthorized multimedia device can be prevented.

FIG. 2 is a block diagram of a structure of the multimedia device 1, which has the backup function. Referring to FIG. 2, the multimedia device 1 includes a receiving unit 12, a storage controlling unit 14, a packaging unit 16, and the local storage unit 10. The multimedia device 1 is connected to the backup device 2. The multimedia device 1 may include various interfaces, such as, a network, a universal serial bus (USB), a blue-tooth, and the like, depending on the type of a backup device used.

The receiving unit 12 performs tuning to receive various broadcasting contents, such as, movies, music, games, and the like, through various broadcasting media, such as, terrestrial broadcasting, satellite broadcasting, cable broadcasting, or DMB. The received broadcasting contents are reproduced using a reproducing unit (not shown) and stored in the local storage unit 10 under the control of the storage controlling unit 14.

The storage controlling unit 14 backs up the received broadcasting contents in the backup device 2 when the local storage unit 10 does not have sufficient capacity or when a user specially requests a backup. The storage controlling unit 14 receives a user input relating to a backup device and broadcasting contents to be backed up and backs up selected broadcasting contents in a selected backup device. To prevent illegal use of backed-up broadcasting contents, the packaging unit 16 packages the broadcasting contents to be backed up using digital authorization information. The packaged broadcasting contents are backed up in the backup device 2. A method of packaging the broadcasting contents to be backed up using the digital authorization information will be described later.

As described above, the multimedia device 1 can store the received broadcasting contents in the local storage unit 10. When the capacity of the local storage unit 10 is deficient, the multimedia device 1 can back up selected contents in the backup device 2 (e.g., another multimedia device connected to the multimedia device 1 via a network, a USB, a blue-tooth, or the like, an optical disc, in a mobile device, in a portable storage device, or the like). Accordingly, the multimedia device 1 can use a storage space more efficiently.

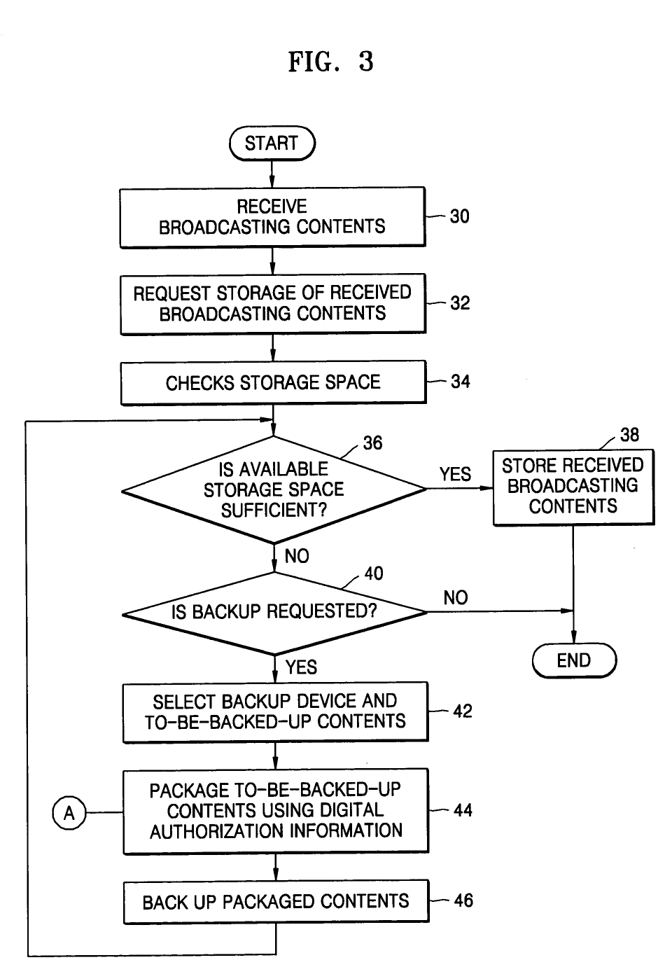

FIG. 3 is a flowchart illustrating a method of backing up broadcasting contents, according to a preferred embodiment of the present invention. Referring to FIG. 3, the multimedia device 1 receives broadcasting contents via various broadcasting media, in operation 30. When a user requests storage of the received broadcasting contents in operation 32, the multimedia device 1 checks if a storage space of the local storage unit 10 is sufficient, in operation 34. When an available storage space of the local storage unit 10 is sufficient in operation 36, the multimedia device 1 stores the received broadcasting contents in the local storage unit 10, in operation 38. On the other hand, when the available storage space of the local storage unit 10 is not sufficient in operation 36, the multimedia device 1 receives a backup request from the user in operation 40. In operation 42, the multimedia device 1 receives information about selection of a backup device and contents to be backed up. The multimedia device 1 packages the to-be-backed-up contents using digital authorization information, which will be described later, to prevent illegal use of backed-up contents, in operation 44. The multimedia device 1 backs up the packaged contents in the selected backup device 2, in operation 46. Although not shown in FIG. 3, not only when the storage space of the local storage unit 10 is deficient, but also when the user requests a backup of already stored broadcasting contents in order to secure a storable space to be used later, this backup method can be applied.

The multimedia device 1 includes the local storage unit 10, in which the received broadcasting contents are stored according to a selection of the user. When broadcasting contents stored in the local storage unit 10 exceed a predetermined level, the multimedia device 1 informs the user that the storable space of the local storage unit 10 is running out of storage space. At this time, when the user wants to back up some of the received broadcasting contents, the multimedia device 1 shows the user backup devices 2, in which the user is authorized to back up contents, among backup devices that the user can use over a home network. The user selects a desired backup device 2 and contents to be backed up. The multimedia device 1 backs up the selected contents in the selected back device 2, thereby efficiently controlling the storable space of the local storage unit 10.

Preferably, the multimedia device 1 provides a user interface so that the user can select the desired backup device and the contents to be backed up. Also, to prevent illegal copying of backed-up contents, the multimedia device 1 should prevent backed-up contents from being reproduced or copied by another unauthorized multimedia device. To do this, the multimedia device 1 packages the to-be-backed-up contents using digital authorization information.

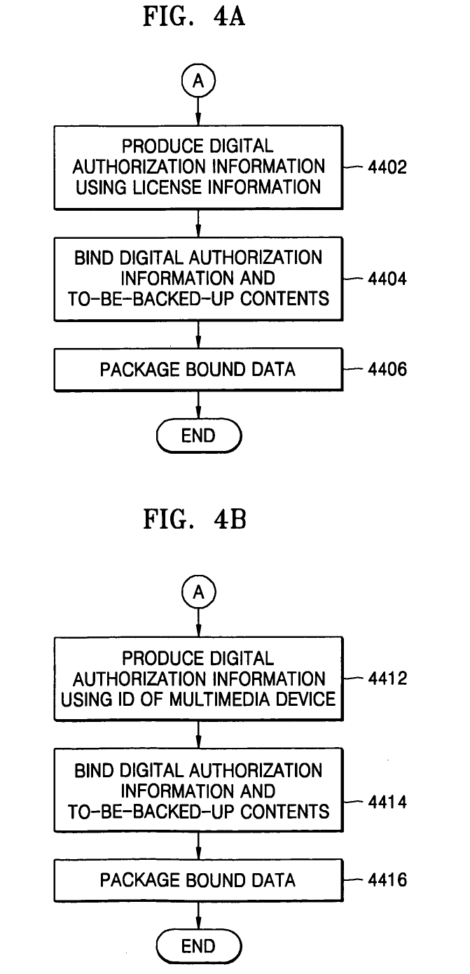

FIGS. 4A and 4B are flowcharts illustrating examples of the contents packaging method using digital authorization information shown in FIG. 3. FIG. 4A illustrates a contents packaging method using license information according to a preferred embodiment of the present invention. Referring to FIG. 4A, the multimedia device 1 produces the digital authorization information from the license information before backing up contents, in operation 4402. Then, the multimedia device 1 binds the digital authorization information and the contents to be backed up, in operation 4404. Thereafter, the multimedia device 1 encrypts or encodes the bound data, in operation 4406. The encryption and encoding of the bound data is expressed as packaging.

FIG. 4B illustrates a contents packaging method using identification information which is unique to the multimedia device 1, according to another preferred embodiment of the present invention. Referring to FIG. 4B, the multimedia device 1 produces the digital authorization information by using the identification information (hereinafter, referred to as ID) as a key before backing up contents, in operation 4412. Next, the digital authorization information and the contents to be backed up are bound, in operation 4414. Then, the bound data is packaged, in operation 4416.

Due to execution of such a packaging process using digital authorization information, contents backed up by a multimedia device can be prevented from being reproduced or copied by another unauthorized multimedia device.

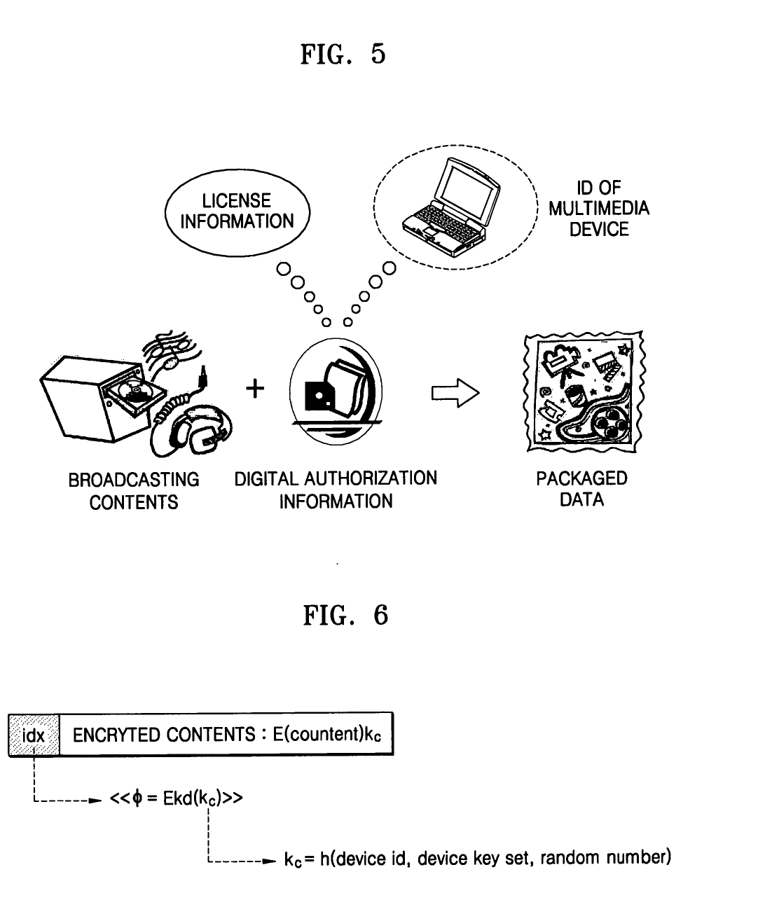

FIG. 5 is a reference view illustrating the contents packaging methods of FIGS. 4A and 4B. Referring to FIG. 5, as illustrated in FIGS. 4A and 4B, the digital authorization information is produced from the license information or an ID of the multimedia device 1 and bound together with the broadcasting contents to be backed up, and a result of the binding is newly encrypted or encoded. As a result, packaged data that cannot be illegally used can be obtained.

FIG. 6 illustrates an embodiment of a protocol in which digital authorization information and contents are bound together. Referring to FIG. 6, key information produced using an ID of a multimedia device to receive and reproduce the contents is used as the digital authorization information. The ID of the multimedia device may be a variety of information, such as, an identification (ID) of the multimedia device, a key set thereof, or a random number produced by the multimedia device. Hence, unless the ID of the multimedia device is known, another multimedia device cannot decode the packaged data, and therefore cannot reproduce backed-up contents.

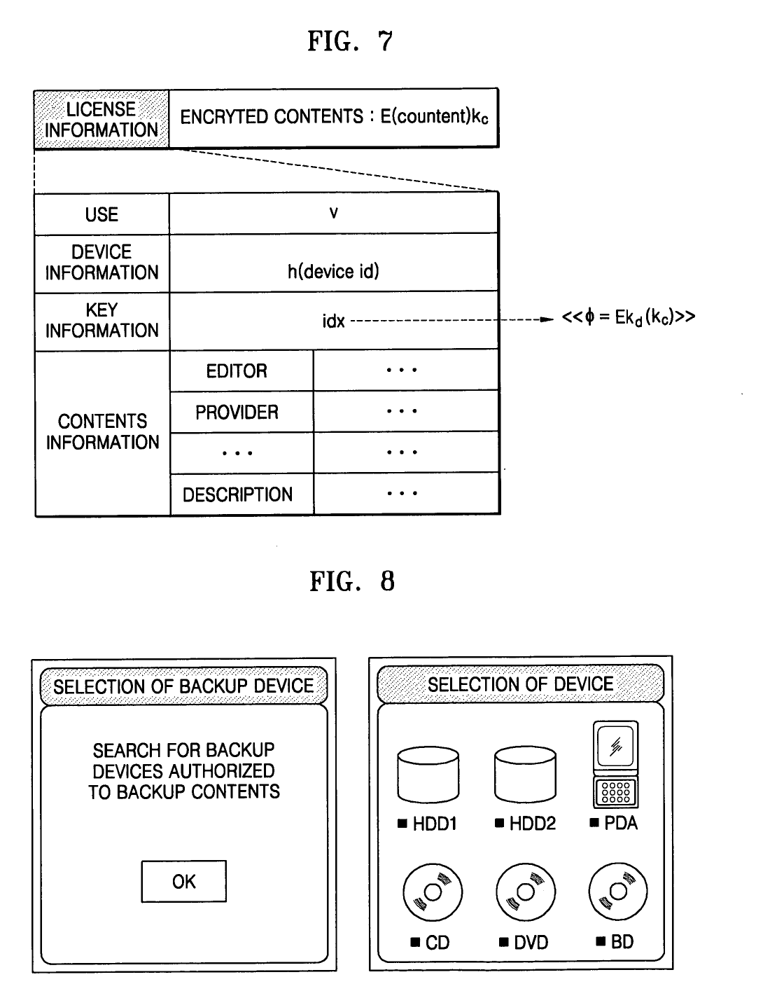

FIG. 7 illustrates another embodiment of a protocol in which digital authorization information and contents are bound together. Referring to FIG. 7, license information is used as the digital authorization information. The license information may include a variety of authorization information, such as, a description about the contents, a rule regarding the use of the contents, and key information. Hence, only multimedia devices or users indicated by the license information are allowed to reproduce the contents, so that illegal use of the backed-up contents is prevented.

FIG. 8 illustrates a user interface for selecting a backup device, according to a preferred embodiment of the present invention. Referring to FIG. 8, the multimedia device 1 searches for backup devices in which a user or the multimedia device 1 has authorization to back up contents and displays the found backup devices so that the user can easily select a desired backup device.

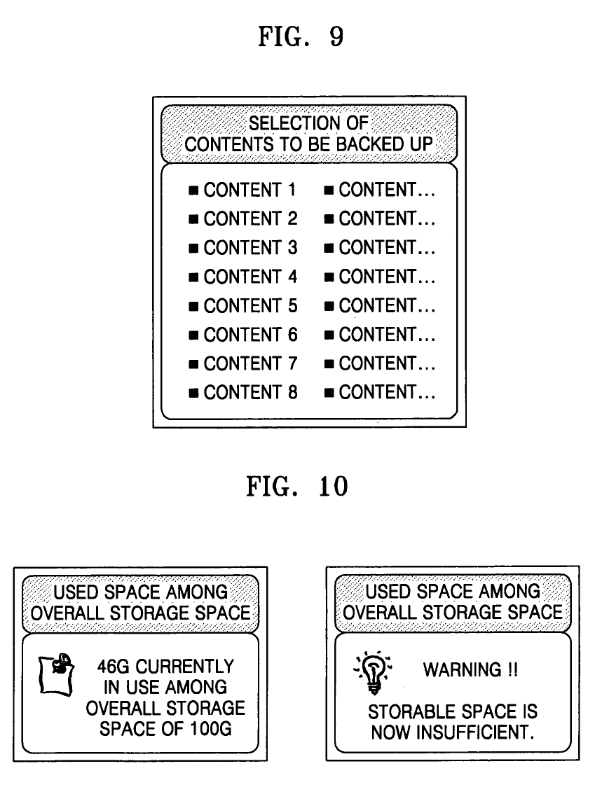

FIG. 9 illustrates a user interface for selecting contents to be backed up, according to a preferred embodiment of the present invention. Referring to FIG. 9, the multimedia device 1 displays a list of contents stored in the local storage unit 10 so that the user can easily select contents desired to be backed up.

FIG. 10 illustrates an example of a user interface for informing users of the capacity of the local storage unit 10 during backup. As shown in FIG. 10, the multimedia device 1 displays a space being used from the total storable space of the local storage unit 10 (or an available storage space of the local storage unit 10) and also displays a warning message if a storable space is insufficient when broadcasting contents are stored.

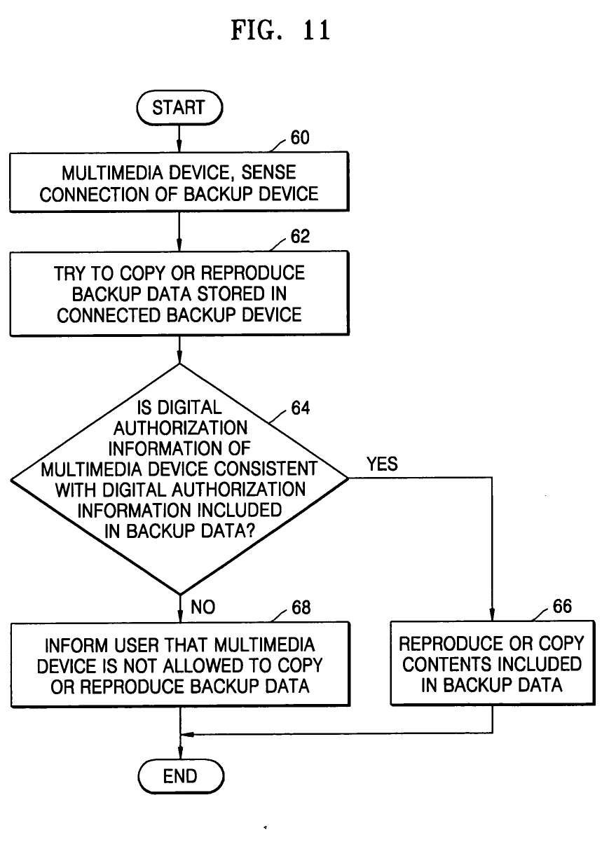

FIG. 11 is a flowchart illustrating a method of preventing contents backed up by a multimedia device from being copied or reproduced by another unauthorized multimedia device. Referring to FIG. 1, when another multimedia device senses that a backup device is connected thereto in operation 60, the multimedia device tries to copy or reproduce backup data stored in the connected backup device, in operation 62. The backup data is data obtained by packaging contents using digital authorization information. When digital authorization information of the multimedia device is consistent with the digital authorization information included in the packaged data in operation 64, the multimedia device can reproduce or copy the contents included in the backup data, in operation 66. On the other hand, when the digital authorization information of the multimedia device is inconsistent with the digital authorization information included in the packaged data in operation 64, a user is informed that the multimedia device is not allowed to copy or reproduce the backup data, in operation 68.

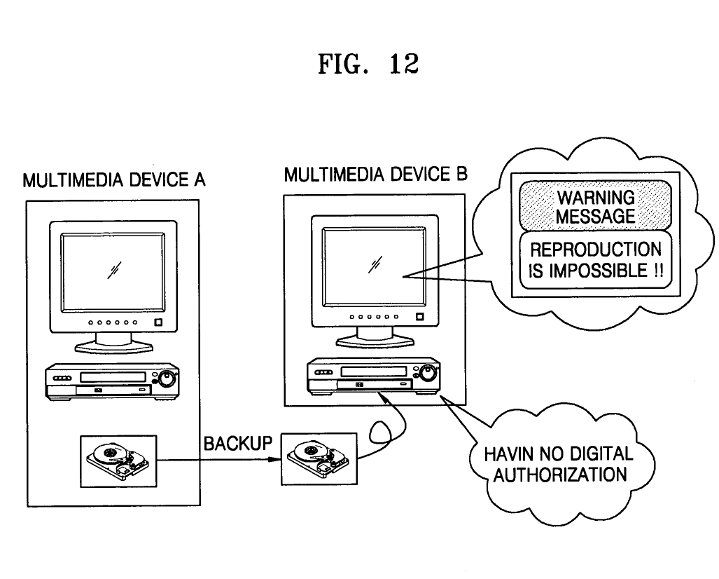

FIG. 12 is a reference view illustrating a method of preventing contents backed up by a multimedia device A from being copied or reproduced by an unauthorized multimedia device B. Referring to FIG. 12, the multimedia device A receives and backs up broadcasting contents including digital authorization information in a backup device. When the unauthorized multimedia device B is connected to the backup device and wants to reproduce backed-up broadcasting contents from the backup device, the multimedia device B displays a warning message informing that reproduction is impossible.

As described above, the preferred embodiments of the present invention provide a multimedia device having a function of backing up broadcasting contents in a home network environment and a method of backing up broadcasting contents.

The multimedia device backs up received broadcasting contents in various backup devices, thereby efficiently controlling a storage space of a local storage unit.

Also, the multimedia device packages broadcasting contents using digital authorization information, thereby preventing backed-up contents from being arbitrarily reproduced or copied by another unauthorized multimedia device. In other words, contents to be backed up is appropriately processed so as not to be copied or reproduced without permission by other multimedia devices and thereafter backed up in a backup device. Thus, illegal copying and circulation of contents can be prevented.

A method of backing up broadcasting contents according to the preferred embodiment of the present invention can be embodied as a computer program. Functional codes and code segments that constitute the computer program can be easily construed by programmers skilled in the art to which the present invention pertains. The computer program is stored in computer readable media. Examples of the computer readable media include optical recording media, magnetic recording media, and carrier waves.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A device for receiving broadcasting contents, the device comprising:
a local storage unit storing received broadcasting contents; and
a storage controlling unit controlling storage of the broadcasting contents,
wherein when one of a space of the local storage unit is insufficient and a user requests a backup, the storage controlling unit controls the device to transfer some of the stored broadcasting contents to the backup device.

2. The device of claim 1, further comprising a packaging unit operable for combining the received broadcasting contents with digital authorization information, and encoding a result of the combination.

3. The device of claim 2, wherein the digital authorization information is produced using information unique to the device.

4. The device of claim 2, wherein the digital authorization information is produced using license information.

5. The device of claim 1, further comprising a receiving unit receiving the broadcasting contents via a broadcasting medium selected from the group consisting of: at least one terrestrial wave broadcasting medium, a cable broadcasting medium, a satellite broadcasting medium, and a digital multimedia broadcasting medium.

6. The device of claim 1, wherein:
the backup device is at least one device selected from: a multimedia device connected to the broadcasting contents receiving device over a network and including a storage unit, a mobile device including a storage unit, a personal video recorder including a storage unit, a settop box including a storage unit, and a separable information storage media.

7. The device of claim 1, further comprising a user interface for selecting broadcasting contents to be transferred to and stored in the backup device and for selecting a backup device to back up the selected broadcasting contents among available backup devices.

8. A method of receiving and storing broadcasting contents, comprising:
determining a capacity of a storage space for storing received broadcasting contents; and
transferring some of the stored broadcasting contents to a backup device when it is determined that the storage space capacity is insufficient.

9. The method of claim 8, before the transferring of some broadcasting contents to the backup device, further comprising combining the some broadcasting contents with digital authorization information and encoding a result of the combination.

10. The method of claim 9, wherein the digital authorization information is produced using information unique to the multimedia device.

11. The method of claim 9, wherein the digital authorization information is produced using license information.

12. The method of claim 8, before determining the capacity of the storage space, further comprising receiving the broadcasting contents via a broadcasting medium selected from the group consisting of at least one of: a terrestrial wave broadcasting medium, a cable broadcasting medium, a satellite broadcasting medium, and a digital multimedia broadcasting medium.

13. The method of claim 8, wherein:
the backup device is at least one device selected from: a multimedia device connected to the broadcasting contents receiving device over a network and including a storage unit, a mobile device including a storage unit, a personal video recorder including a storage unit, a settop box including a storage unit, and separable information storage media; and
in the transferring and storing of the some broadcasting contents in the backup device, the some of the stored broadcasting contents are transferred to the backup device.

14. The method of claim 8, before the transferring and storing of the some of the stored broadcasting contents in the backup device, further comprising receiving information about selection of contents of the stored broadcasting contents to be transferred, and receiving information of a backup device to back up the selected contents.

15. A computer readable recording medium which records a computer program code for executing the method of claim 8.

16. A method of backing up stored broadcasting contents, comprising:
receiving a user request for a backup of the stored broadcasting contents;
combining the broadcasting contents to be backed up with digital authorization information, and encoding the combined contents and information to form encoded data; and
transferring the encoded data to a backup device.
